(19) United States
(12) Patent Application Publication
(10) Pub. No.: US 2018/0027470 A1
(43) Pub. Date: Jan. 25, 2018

(54) DATA TRANSMISSION METHOD AND APPARATUS IN TIME DIVISION DUPLEX WIRELESS DATA TRANSMISSION SYSTEM, AND SYSTEM

(71) Applicant: HUAWEI TECHNOLOGIES CO., LTD., Shenzhen (CN)

(72) Inventors: Qiong LI, Xi'an (CN); Shaofeng XU, Xi'an (CN)

(73) Assignee: HUAWEI TECHNOLOGIES CO., LTD., Shenzhen (CN)

(21) Appl. No.: 15/722,124

(22) Filed: Oct. 2, 2017

Related U.S. Application Data
(63) Continuation of application No. PCT/CN2015/075870, filed on Apr. 3, 2015.

(51) Int. Cl. H04W 36/30; H04L 5/14; H04L 5/22; H04J 3/16

(52) U.S. Cl. CPC H04W 36/30; H04J 3/1605; H04L 5/14; H04L 5/22

(57) ABSTRACT

The present invention provides a data transmission method and apparatus in a time division duplex wireless data transmission system, and a system. The method includes: performing, by a transmission device in a timeslot corresponding to an idle frame, interference detection on a to-be-detected frequency band corresponding to the idle frame, obtaining an interference detection result, updating interference statistics, and switching, according to the interference statistics when interference to a current operating frequency band is greater than a preset threshold, the operating frequency band to a frequency band that meets a condition. Therefore, service interruption caused by interference detection is avoided.

### CROSS-REFERENCE TO RELATED APPLICATIONS

This application is a continuation of International Application No. PCT/CN2015/075870, filed on Apr. 3, 2015, the disclosure of which is hereby incorporated by reference in its entirety.

### TECHNICAL FIELD

The present invention relates to communications technologies, and in particular, to a data transmission method and apparatus in a time division duplex wireless data transmission system, and a system.

### BACKGROUND

In a microwave transmission system, because a spectrum of an unlicensed (unlicence) frequency band is free, use of the frequency band for transmission can reduce substantial operation and maintenance costs for a communications operator. However, due to openness of the spectrum of the unlicensed frequency band, multiple types of complex interference exist, and affect normal operating of the microwave transmission system. Therefore, how to avoid interference is particularly important for the microwave transmission system.

In the prior art, initial frequency band scanning is performed after a microwave transmission system is powered on, all bandwidth in an available frequency band range is scanned, all frequency band scanning information is stored in a frequency configuration table, and a frequency band that is least interfered with is selected for data transmission. If multiple times of frequency band switching fail because a frequency band in the frequency configuration table is also interfered with in use, frequency band scanning is triggered again, an available frequency band is obtained in real time, and switching to the available frequency band is performed, so as to avoid interference.

However, by using the prior art, on an unlicensed frequency band, a frequency band that is not interfered with during initial scanning is easily interfered with in a subsequent operating process. Therefore, there is a high probability of triggering frequency band scanning again, and service interruption is caused. Particularly, in a case of a relatively wide unlicensed frequency band, a time for completing one time of frequency band scanning is relatively long, and a service interruption time is also relatively long.

### SUMMARY

Embodiments of the present invention provide a data transmission method and apparatus in a time division duplex wireless data transmission system, and a system, so as to resolve a possible service interruption problem in a data transmission process in an existing microwave transmission system.

A first aspect of the embodiments of the present invention provides a data transmission method in a time division duplex wireless data transmission system, including:

receiving, by a second transmission device, a service frame sent by a first transmission device, and receiving an idle frame that is sent by the first transmission device after each time the first transmission device sends a preset quantity of service frames;

performing, by the second transmission device in a timeslot corresponding to the idle frame, interference detection on a to-be-detected frequency band corresponding to the idle frame in an available spectrum, obtaining an interference detection result of the to-be-detected frequency band, and updating the interference detection result of the to-be-detected frequency band in interference statistics of the available spectrum; and

switching, by the second transmission device according to the interference statistics of the available spectrum when interference to a current operating frequency band is greater than a preset threshold, the operating frequency band to a frequency band that meets a preset condition.

A second aspect of the embodiments of the present invention provides a data transmission apparatus in a time division duplex wireless data transmission system, comprising a processor and a transmitter, wherein

the processor is configured to: generate an idle frame and a service frame;

the transmitter is configured to: send the service frame to a second transmission device; send the idle frame to the second transmission device after each time the first transmission device sends a preset quantity of service frames to the second transmission device.

A third aspect of the embodiments of the present invention provides a data transmission apparatus in a time division duplex wireless data transmission system, including a receiver and a processor, where

the receiver is configured to: receive a service frame sent by a first transmission device, and receive an idle frame that is sent by the first transmission device after each time the first transmission device sends a preset quantity of service frames; and

the processor is configured to: perform, in a timeslot corresponding to the idle frame, interference detection on a to-be-detected frequency band corresponding to the idle frame in an available spectrum, obtain an interference detection result of the to-be-detected frequency band, and update the interference detection result of the to-be-detected frequency band in interference statistics of the available spectrum; and switch, according to the interference statistics of the available spectrum when interference to a current operating frequency band is greater than a preset threshold, the operating frequency band to a frequency band that meets a preset condition.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show some embodiments of the present invention, and persons of ordinary skill in the art may still derive other drawings from these accompanying drawings without creative efforts.

FIG. 1 is a schematic structural diagram of Embodiment 1 of a time division duplex wireless data transmission system according to the present invention;

FIG. 2 is a schematic flowchart of Embodiment 1 of a data transmission method in a time division duplex wireless data transmission system according to the present invention:

FIG. 3 is a schematic flowchart of Embodiment 2 of a data transmission method in a time division duplex wireless data transmission system according to the present invention;

FIG. 4 is a schematic flowchart of Embodiment 3 of a data transmission method in a time division duplex wireless data transmission system according to the present invention:

FIG. 5 is a schematic structural diagram of Embodiment 1 of a data transmission apparatus in a time division duplex wireless data transmission system according to the present invention;

FIG. 6 is a schematic structural diagram of Embodiment 2 of a data transmission apparatus in a time division duplex wireless data transmission system according to the present invention; and

FIG. 7 is a schematic structural diagram of Embodiment 3 of a data transmission apparatus in a time division duplex wireless data transmission system according to the present invention.

### DESCRIPTION OF EMBODIMENTS

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention without creative efforts shall fall within the protection scope of the present invention.

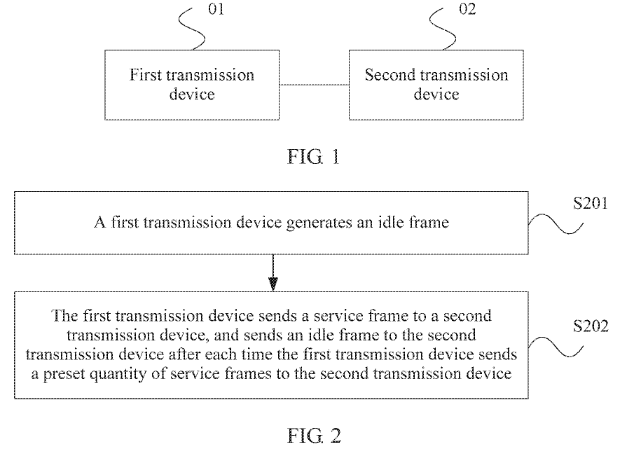

FIG. 1 is a schematic structural diagram of Embodiment 1 of a time division duplex wireless data transmission system according to the present invention. As shown in FIG. 1, the system includes a first transmission device 01 and a second transmission device 02. The first transmission device 01 is a data transmitter device, and the second transmission device 02 is a data receiver device. The time division duplex (TDD) data transmission system may be a TDD microwave transmission system. The second transmission device 02 may be powered on to capture frame synchronization information of the first transmission device 01, so as to synchronize with the first transmission device 01.

It should be noted that the TDD data transmission system is generally a half-duplex system. In the system, the two devices are not limited as a transmitter or a receiver, but are determined according to a data stream direction. When a data stream flows from the first transmission device 01 to the second transmission device 02, the first transmission device 01 is used as a transmitter device, and the second transmission device 02 is used as a receiver device. On the contrary, the first transmission device 01 may be used as a receiver device, and the second transmission device 02 may be used as a transmitter device.

The first transmission device 01 and the second transmission device 02 may have exactly the same internal structures, and may include a modem and a central processing unit (CPU). The modem may be configured to generate an idle frame and perform interference detection. Specifically, a modem of a transmitter is configured to generate an idle frame, and a modem of a receiver is configured to perform interference detection. The CPU is configured to: determine interference magnitude according to an interference detection result, and select an operating frequency band.

In this embodiment, the first transmission device 01 is used as a transmitter device, and the second transmission device 02 is used as a receiver device.

Specifically, the first transmission device 01 is configured to: send a service frame to the second transmission device, and send an idle frame to the second transmission device 02 after each time the first transmission device 01 sends a preset quantity of service frames to the second transmission device 02. That is, the first transmission device 01 periodically sends the service frame and the idle frame, and sends an idle frame at an interval of the preset quantity of service frames. The idle frame does not include any service information.

In a specific implementation process, after the first transmission device 01 is synchronized with the second transmission device 02, the first transmission device 01 sends idle frame sending period negotiation information to the second transmission device 02, and the second transmission device 02 may learn, according to the idle frame sending period negotiation information, a period of sending the idle frame by the first transmission device 01.

The second transmission device 02 is configured to: perform, in a timeslot corresponding to the idle frame, interference detection on a to-be-detected frequency band corresponding to the idle frame in an available spectrum, obtain an interference detection result of the to-be-detected frequency band, and update the interference detection result of the to-be-detected frequency band in interference statistics of the available spectrum.

Other frequency bands than a current operating frequency band in the available spectrum may be used as to-be-detected frequency bands.

Interference detection results of all frequency bands in the available spectrum are recorded in the interference statistics, and may be recorded in a form of a table. After detection of the to-be-detected frequency band is completed, corresponding data in the interference statistics is updated.

For example, assuming that a total current available frequency band is 81-82 G and bandwidth of a transmission device is set to 250 M, the available frequency band may be divided into four frequency bands (band): 81 G-81.25 G 81.25 G-81.5 G 81.5 G-81.75 G, and 81.75 G-82 G. If a current operating frequency band is 81.25-81.5 G, interference detection is performed only on the three other bands. Specifically, to-be-detected frequency bands may be determined according to a particular preset sequence, and interference detection is performed on the to-be-detected frequency bands. For example, after the first idle frame is received, interference detection is performed on 81 G-81.25 G in a timeslot corresponding to the first idle frame; after the second idle frame is received, interference detection is performed on 81.5 G-81.75 G in a timeslot corresponding to the second idle frame; and after the third idle frame is received, interference detection is performed on 81.75 G-82 G in a timeslot corresponding to the third idle frame.

The second transmission device 02 is configured to switch, according to the interference statistics of the available spectrum when interference to a current operating frequency band is greater than a preset threshold, the operating frequency band to a frequency band that meets a preset condition.

Specifically, when detecting that the interference to the current operating frequency band is greater than the preset threshold, the second transmission device 02 triggers frequency band switching. The second transmission device 02 selects, according to the current interference statistics, a frequency band that is less interfered with as a new operating frequency band, and hands over all services to the new operating frequency band for processing.

Generally, in the system, an operating frequency band is pre-configured to process all the services. If the pre-configured operating frequency band is interfered with, a new operating frequency band is selected, and all the services are handed over to the new operating frequency band for processing.

The second transmission device 02 collects statistics about a mean square error (MES) signal of an operating frequency band, when finding that quality of the MES signal deteriorates, detects whether the operating frequency band is interfered with, and when detecting that the interference to the current operating frequency band is greater than the preset threshold, triggers frequency band switching, that is, reports a frequency band switching request to a CPU of the second transmission device, and the CPU selects a frequency band that is currently least interfered with as a new operating frequency band.

In this embodiment, a first transmission device sends an idle frame to a second transmission device after each time the first transmission device sends a preset quantity of service frames to the second transmission device. The second transmission device performs, in a timeslot corresponding to the idle frame, interference detection on a to-be-detected frequency band corresponding to the idle frame in an available spectrum, obtains an interference detection result, updates interference statistics of the available spectrum, and switches, according to the interference statistics of the available spectrum when interference to a current operating frequency band is greater than a preset threshold, the operating frequency band to a frequency band that meets a preset condition. In this way, interference detection is performed in an idle frame, and service interruption is avoided. In addition, interference detection is performed at an interval of a period of time, so that a status of interference to each frequency band can be updated in a timely manner, and a switching failure that is caused due to interference to a selected frequency band is avoided.

Further, that the second transmission device 02 is configured to perform, in a timeslot corresponding to the idle frame, interference detection on a to-be-detected frequency band corresponding to the idle frame in an available spectrum may be specifically: the second transmission device 02 switches, in the timeslot corresponding to the idle frame, the current operating frequency band to the to-be-detected frequency band corresponding to the idle frame, and performs interference detection on the to-be-detected frequency band.

The foregoing example is used for description. If the current operating frequency band is 81.25 G-81.5 G, after the first idle frame is received, and interference detection is performed on 81 G-81.25 G in the timeslot corresponding to the first idle frame, the current operating frequency band is switched from 81.25 G-81.5 G to 81 G-81.25 G, and interference detection is performed on 81 G-81.25 G. After detection is completed, the current operating frequency band is switched to the original operating frequency band 81.25-81.5 G again.

That the second transmission device 02 is configured to perform interference detection on the to-be-detected frequency band is specifically: the second transmission device 02 obtains received signal strength indication (RSSI) information of the to-be-detected frequency band to perform interference detection on the available spectrum, and obtains the interference detection result. However, this constitutes no limitation. Interference detection is mainly performed to detect various types of interference to the to-be-detected frequency band in an environment.

Further, the second transmission device 02 updates the interference statistics, and may update the RSSI information of the to-be-detected frequency band in an interference statistics table. Specifically, the second transmission device 02 may establish an interference statistics table. The interference statistics table stores interference-related information of each frequency band in the available spectrum. For example, the interference statistics table may) be shown in Table 1.

TABLE 1

| | | Magnitude of signal | |
|---|---|---|---|
| Frequency band | Available or not | interference | Storage time |
| f1 | Y | A | xx: xx |
| f2 | Y | A + X1 (dB) | xx: xx |
| f3 | X | A + X2 (dB) | xx: xx |
| f4 | X | A + X2 (dB) | xx: xx |
| . . . | . . . | . . . | . . . |
| . . . | . . . | . . . | . . . |
| fn | Y | A + Xn (dB) | xx: xx |

Based on the foregoing embodiment, that the second transmission device 02 is configured to switch, according to the interference statistics of the available spectrum when interference to a current operating frequency band is greater than a preset threshold, the operating frequency band to a frequency band that meets a preset condition is specifically: the operating frequency band is switched, according to the interference statistics of the available spectrum when the interference to the current operating frequency band is greater than the preset threshold, to a frequency band that is least interfered with. In a specific implementation process, magnitude of signal interference to each frequency band may be analyzed according to RSSI information of each frequency band, and the frequency band that is least interfered with is selected as a new operating frequency band.

In another embodiment, the second transmission device 02 may further determine a priority of each frequency band in the available spectrum according to RSSI information of each frequency band in the interference statistics of the available spectrum, where interference to a frequency band with a high priority is less than that to a frequency band with a low priority.

Specifically, a priority column may be added to the interference statistics table, and the priority corresponding to each frequency band is identified. Sorting may be performed in descending order of priorities, and a frequency band with a high priority is ranked in the front of the interference statistics table.

In a specific implementation process, that the second transmission device 02 is configured to switch, according to the interference statistics of the available spectrum when interference to a current operating frequency band is greater than a preset threshold, the operating frequency band to a frequency band that meets a preset condition is specifically: when the interference to the current operating frequency band is greater than the preset threshold, the second transmission device 02 switches the operating frequency band to a frequency band with a highest priority according to the priority of each frequency band in the available spectrum. That is, the operating frequency band is switched to a frequency band that is least interfered with.

FIG. 2 is a schematic flowchart of Embodiment 1 of a data transmission method in a time division duplex wireless data transmission system according to the present invention. Based on the foregoing embodiment, a first transmission device is used as an execution body, and the method includes the following steps:

S201. The first transmission device generates an idle frame, where the idle frame does not include any service information.

S202. The first transmission device sends a service frame to a second transmission device, and sends an idle frame to the second transmission device after each time the first transmission device sends a preset quantity of service frames to the second transmission device.

The first transmission device is a data transmitter device, and the second transmission device is a data receiver device.

In this embodiment, a first transmission device generates an idle frame, and sends an idle frame to a second transmission device after each time the first transmission device sends a preset quantity of service frames to the second transmission device. The second transmission device performs, in a timeslot corresponding to the idle frame, interference detection on an available spectrum, and obtains an interference detection result. Because no service needs to be executed in a timeslot corresponding to an idle frame, service interruption is avoided. In addition, interference detection is performed at an interval of a period of time, so that a status of interference to each frequency band can be updated in a timely manner.

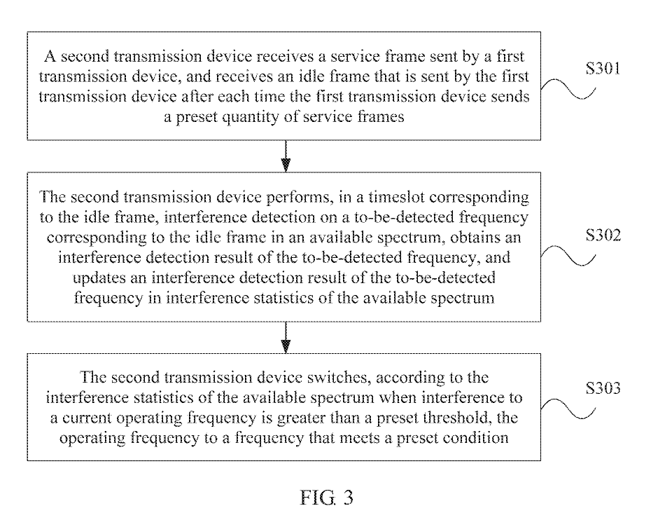

FIG. 3 is a schematic flowchart of Embodiment 2 of a data transmission method in a time division duplex wireless data transmission system according to the present invention. Based on the foregoing embodiment, a second transmission device is used as an execution body, and the method includes the following steps.

S301. The second transmission device receives a service frame sent by a first transmission device, and receives an idle frame that is sent by the first transmission device after each time the first transmission device sends a preset quantity of service frames.

The idle frame does not include any service information. That is, the second transmission device does not need to execute any service in a timeslot corresponding to the idle frame.

S302. The second transmission device performs, in a timeslot corresponding to the idle frame, interference detection on a to-be-detected frequency band corresponding to the idle frame in an available spectrum, obtains an interference detection result of the to-be-detected frequency band, and updates the interference detection result of the to-be-detected frequency band in interference statistics of the available spectrum.

S303. The second transmission device switches, according to the interference statistics of the available spectrum when interference to a current operating frequency band is greater than a preset threshold, the operating frequency band to a frequency band that meets a preset condition.

The first transmission device is a data transmitter device, and the second transmission device is a data receiver device.

In this embodiment, a second transmission device performs, in a timeslot corresponding to an idle frame, interference detection on a to-be-detected frequency band corresponding to the idle frame in an available spectrum, obtains an interference detection result of the to-be-detected frequency band, updates the interference detection result of the to-be-detected frequency band in interference statistics of the available spectrum, and switches, according to the interference statistics of the available spectrum when interference to a current operating frequency band is greater than a preset threshold, the operating frequency band to a frequency band that meets a preset condition. Therefore, interference detection is performed in an idle frame, and service interruption is avoided. In addition, interference detection is performed at an interval of a period of time, so that a status of interference to each frequency band can be updated in a timely manner, and a switching failure that is caused due to interference to a selected frequency band is avoided.

Based on the foregoing embodiment, that the second transmission device performs, in a timeslot corresponding to the idle frame, interference detection on a to-be-detected frequency band corresponding to the idle frame in an available spectrum may be: the second transmission device switches, in the timeslot corresponding to the idle frame, the current operating frequency band to the to-be-detected frequency band corresponding to the idle frame, and performs interference detection on the to-be-detected frequency band. Certainly, this constitutes no limitation, and interference detection may be performed according to another parameter. For details, refer to the foregoing system embodiment. Details are not described herein again.

In another embodiment, that the second transmission device performs interference detection on the to-be-detected frequency band may be specifically: the second transmission device obtains RSSI information of the to-be-detected frequency band to perform interference detection on the to-be-detected frequency band.

Based on the foregoing embodiment, in another embodiment, after the second transmission device performs interference detection on the to-be-detected frequency band in the timeslot corresponding to the idle frame, and obtains the interference detection result, the second transmission device may update the interference detection result of the to-be-detected frequency band in the interference statistics of the available spectrum. Specifically, for the interference statistics table, refer to Table 1. Details are not described herein again.

Correspondingly, that the second transmission device switches, according to the interference statistics of the available spectrum when interference to a current operating frequency band is greater than a preset threshold, the operating frequency band to a frequency band that meets a preset condition may be: the second transmission device switches, according to the interference statistics of the available spectrum when the interference to the current operating frequency band is greater than the preset threshold, the operating frequency band to a frequency band that is least interfered with.

Further, in another embodiment, after the second transmission device obtains the RSSI information of the to-be-detected frequency band to perform interference detection on the to-be-detected frequency band, the second transmission device may further determine a priority of each frequency band in the available spectrum according to RSSI information of each frequency band in the available spectrum. Specifically, the second transmission device may record the priority of each frequency band in the available spectrum in the interference statistics of the available spectrum. Interference to a frequency band with a high priority is less than that to a frequency band with a low priority.

Correspondingly, that the second transmission device switches, according to the interference statistics of the available spectrum when interference to a current operating frequency band is greater than a preset threshold, the operating frequency band to a frequency band that meets a preset condition may be: when the interference to the current operating frequency band is greater than the preset threshold, the second transmission device switches the operating frequency band to a frequency band with a highest priority according to the priority of each frequency band in the available spectrum.

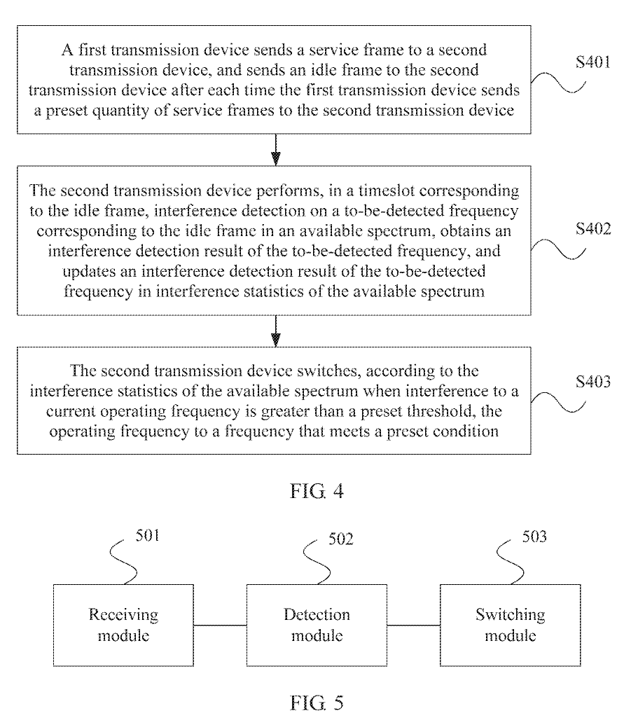

FIG. 4 is a schematic flowchart of Embodiment 3 of a data transmission method in a time division duplex wireless data transmission system according to the present invention. For the time division duplex wireless data transmission system, refer to the embodiment shown in FIG. 1. The method is a method executed in the system shown in FIG. 1. Specifically, the method includes the following steps.

S401. A first transmission device sends a service frame to a second transmission device, and sends an idle frame to the second transmission device after each time the first transmission device sends a preset quantity of service frames to the second transmission device.

The idle frame does not include any service information.

S402. The second transmission device performs, in a timeslot corresponding to the idle frame, interference detection on a to-be-detected frequency band corresponding to the idle frame in an available spectrum, obtains an interference detection result of the to-be-detected frequency band, and updates the interference detection result of the to-be-detected frequency band in interference statistics of the available spectrum.

Other frequency bands than a current operating frequency band in the available spectrum may be used as to-be-detected frequency bands.

Interference detection results of all frequency bands in the available spectrum are recorded in the interference statistics, and may be recorded in a form of a table. After detection of the to-be-detected frequency band is completed, corresponding data in the interference statistics is updated.

For example, assuming that a total current available frequency band is 81-82 G, and bandwidth of a transmission device is set to 250 M, the available frequency band may be divided into four frequency bands (band): 81 G-81.25 G 81.25 G-81.5 G, 81.5 G-81.75 G and 81.75 G-82 G. If a current operating frequency band is 81.25-81.5 G, interference detection is performed only on the three other bands. Specifically, to-be-detected frequency bands may be determined according to a particular preset sequence, and interference detection is performed on the to-be-detected frequency bands. For example, after the first idle frame is received, interference detection is performed on 81 G-81.25 G in a timeslot corresponding to the first idle frame; after the second idle frame is received, interference detection is performed on 81.5 G-81.75 G in a timeslot corresponding to the second idle frame; and after the third idle frame is received, interference detection is performed on 81.75 G-82 G in a timeslot corresponding to the third idle frame.

S403. The second transmission device switches, according to the interference statistics of the available spectrum when interference to a current operating frequency band is greater than a preset threshold, the operating frequency band to a frequency band that meets a preset condition.

Specifically, when detecting that the interference to the current operating frequency band is greater than the preset threshold, the second transmission device 02 triggers frequency band switching. The second transmission device 02 selects, according to the current interference statistics, a frequency band that is less interfered with as a new operating frequency band, and hands over all services to the new operating frequency band for processing.

Generally, in the system, an operating frequency band is pre-configured to process all the services. If the pre-configured operating frequency band is interfered with, a new operating frequency band is selected, and all the services are handed over to the new operating frequency band for processing.

The second transmission device collects statistics about an MES signal, when finding that quality of the MES signal deteriorates, detects whether the operating frequency band is interfered with, and when detecting that the interference to the current operating frequency band is greater than the preset threshold, triggers frequency band switching, that is, reports a frequency band switching request to a CPU of the second transmission device, and the CPU selects a frequency band that is currently least interfered with as a new operating frequency band.

The first transmission device is a data transmitter device, and the second transmission device is a data receiver device.

In this embodiment, a first transmission device sends a service frame to a second transmission device, and sends an idle frame to the second transmission device after each time the first transmission device sends a preset quantity of service frames to the second transmission device. The second transmission device performs, in a timeslot corresponding to the idle frame, interference detection on a to-be-detected frequency band corresponding to the idle frame in an available spectrum, obtains an interference detection result of the to-be-detected frequency band, updates the interference detection result of the to-be-detected frequency band in interference statistics of the available spectrum, and switches, according to the interference statistics of the available spectrum when interference to a current operating frequency band is greater than a preset threshold, the operating frequency band to a frequency band that meets a preset condition. Therefore, interference detection is performed in an idle frame, and service interruption is avoided. In addition, interference detection is performed at an interval of a period of time, so that a status of interference to each frequency band can be updated in a timely manner, and a switching failure that is caused due to interference to a selected frequency band is avoided.

Further, that the second transmission device performs, in a timeslot corresponding to the idle frame, interference detection on a to-be-detected frequency band corresponding to the idle frame in an available spectrum is specifically: the second transmission device switches, in the timeslot corresponding to the idle frame, the current operating frequency band to the to-be-detected frequency band corresponding to the idle frame, and performs interference detection on the to-be-detected frequency band.

Based on the foregoing embodiment, in another embodiment, that the second transmission device performs interference detection on the to-be-detected frequency band may be: the second transmission device obtains received signal strength indication RSSI information of the to-be-detected frequency band to perform interference detection on the to-be-detected frequency band.

In another embodiment, that the second transmission device switches, according to the interference statistics of the available spectrum when interference to a current operating frequency band is greater than a preset threshold, the operating frequency band to a frequency band that meets a preset condition may be specifically: the second transmission device switches, according to the interference statistics of the available spectrum when the interference to the current operating frequency band is greater than the preset threshold, the operating frequency band to a frequency band that is least interfered with.

In a specific implementation process, after the second transmission device obtains the received signal strength indication RSSI information of the to-be-detected frequency band to perform interference detection on the to-be-detected frequency band, the second transmission device may determine a priority of each frequency band in the available spectrum according to RSSI information of each frequency band in the available spectrum. Interference to a frequency band with a high priority is less than that to a frequency band with a low priority.

Based on this, that the second transmission device switches, according to the interference statistics of the available spectrum when interference to a current operating frequency band is greater than a preset threshold, the operating frequency band to a frequency band that meets a preset condition may be: when the interference to the current operating frequency band is greater than the preset threshold, the second transmission device switches the operating frequency band to a frequency band with a highest priority according to the priority of each frequency band in the available spectrum.

FIG. 5 is a schematic structural diagram of Embodiment 1 of a data transmission apparatus in a time division duplex wireless data transmission system according to the present invention. The apparatus may be integrated into the foregoing second transmission device. As shown in FIG. 5, the apparatus includes a receiving module 501, a detection module 502, and a switching module 503.

The receiving module 501 is configured to: receive a service frame sent by a first transmission device, and receive an idle frame that is sent by the first transmission device after each time the first transmission device sends a preset quantity of service frames.

The detection module 502 is configured to: perform, in a timeslot corresponding to the idle frame, interference detection on a to-be-detected frequency band corresponding to the idle frame in an available spectrum, obtain an interference detection result of the to-be-detected frequency band, and update the interference detection result of the to-be-detected frequency band in interference statistics of the available spectrum.

The switching module 503 is configured to switch, according to the interference statistics of the available spectrum when interference to a current operating frequency band is greater than a preset threshold, the operating frequency band to a frequency band that meets a preset condition.

In this embodiment, the apparatus performs, in a timeslot corresponding to an idle frame, interference detection on a to-be-detected frequency band corresponding to the idle frame in an available spectrum, obtains an interference detection result of the to-be-detected frequency band, updates the interference detection result of the to-be-detected frequency band in interference statistics of the available spectrum, and switches, according to the interference statistics of the available spectrum when interference to a current operating frequency band is greater than a preset threshold, the operating frequency band to a frequency band that meets a preset condition. Therefore, interference detection is performed in an idle frame, and service interruption is avoided. In addition, interference detection is performed at an interval of a period of time, so that a status of interference to each frequency band can be updated in a timely manner, and a switching failure that is caused due to interference to a selected frequency band is avoided.

The detection module 502 is specifically configured to: switch, in the timeslot corresponding to the idle frame, the current operating frequency band to the to-be-detected frequency band corresponding to the idle frame, and perform interference detection on the to-be-detected frequency band.

The detection module 502 is specifically configured to obtain received signal strength indication RSSI information of the to-be-detected frequency band to perform interference detection on the to-be-detected frequency band.

The switching module 503 is specifically configured to switch, according to the interference statistics of the available spectrum when the interference to the current operating frequency band is greater than the preset threshold, the operating frequency band to a frequency band that is least interfered with.

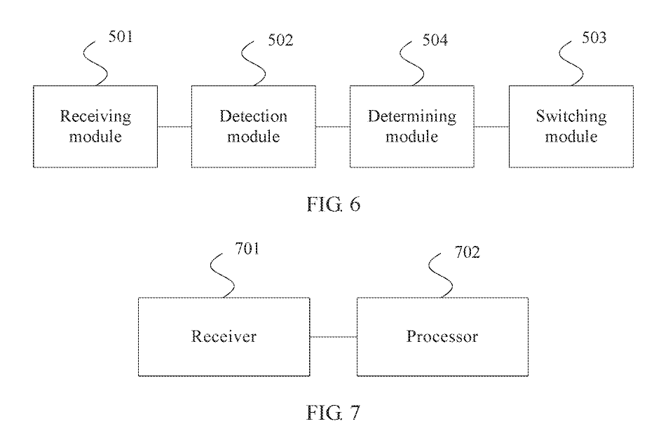

FIG. 6 is a schematic structural diagram of Embodiment 2 of a data transmission apparatus in a time division duplex wireless data transmission system according to the present invention. As shown in FIG. 6, based on FIG. 5, the apparatus further includes a determining module 504, configured to: after the detection module obtains the received signal strength indication RSSI information of the to-be-detected frequency band to perform interference detection on the to-be-detected frequency band, determine a priority of each frequency band in the available spectrum according to RSSI information of each frequency band in the available spectrum. Interference to a frequency band with a high priority is less than that to a frequency band with a low priority.

Based on this, correspondingly, the switching module 503 is specifically configured to: when the interference to the current operating frequency band is greater than the preset threshold, switch the operating frequency band to a frequency band with a highest priority according to the priority of each frequency band in the available spectrum.

The apparatus is configured to implement the method embodiment shown in FIG. 3. An implementation principle and a technical effect of the apparatus are similar to those in the method embodiment shown in FIG. 3, and details are not described herein again.

FIG. 7 is a schematic structural diagram of Embodiment 3 of a data transmission apparatus in a time division duplex wireless data transmission system according to the present invention. The apparatus may be integrated into the foregoing second transmission device. As shown in FIG. 7, the apparatus includes a receiver 701 and a processor 702.

The receiver 701 is configured to: receive a service frame sent by a first transmission device, and receive an idle frame that is sent by the first transmission device after each time the first transmission device sends a preset quantity of service frames.

The processor 702 is configured to: perform, in a timeslot corresponding to the idle frame, interference detection on a to-be-detected frequency band corresponding to the idle frame in an available spectrum, obtain an interference detection result of the to-be-detected frequency band, and update the interference detection result of the to-be-detected frequency band in interference statistics of the available spectrum; and switch, according to the interference statistics of the available spectrum when interference to a current operating frequency band is greater than a preset threshold, the operating frequency band to a frequency band that meets a preset condition.

In this embodiment, the apparatus performs, in a timeslot corresponding to an idle frame, interference detection on a to-be-detected frequency band corresponding to the idle frame in an available spectrum, obtains an interference detection result of the to-be-detected frequency band, updates the interference detection result of the to-be-detected frequency band in interference statistics of the available spectrum, and switches, according to the interference statistics of the available spectrum when interference to a current operating frequency band is greater than a preset threshold, the operating frequency band to a frequency band that meets a preset condition. Therefore, interference detection is performed in an idle frame, and service interruption is avoided. In addition, interference detection is performed at an interval of a period of time, so that a status of interference to each frequency band can be updated in a timely manner, and a switching failure that is caused due to interference to a selected frequency band is avoided.

The processor 702 is specifically configured to: switch, in the timeslot corresponding to the idle frame, the current operating frequency band to the to-be-detected frequency band corresponding to the idle frame, and perform interference detection on the to-be-detected frequency band.

Specifically, the processor 702 may be configured to obtain received signal strength indication RSSI information of the to-be-detected frequency band to perform interference detection on the to-be-detected frequency band.

The processor 702 is specifically configured to switch, according to the interference statistics of the available spectrum when the interference to the current operating frequency band is greater than the preset threshold, the operating frequency band to a frequency band that is least interfered with.

In another embodiment, the processor 702 is further configured to: after obtaining the received signal strength indication RSSI information of the to-be-detected frequency band to perform interference detection on the to-be-detected frequency band, determine a priority of each frequency band in the available spectrum according to RSSI information of each frequency band in the available spectrum. Interference to a frequency band with a high priority is less than that to a frequency band with a low priority.

Based on this, the processor 702 is specifically configured to: when the interference to the current operating frequency band is greater than the preset threshold, switch the operating frequency band to a frequency band with a highest priority according to the priority of each frequency band in the available spectrum.

The apparatus is configured to implement the method embodiment shown in FIG. 3. An implementation principle and a technical effect of the apparatus are similar to those in the method embodiment shown in FIG. 3, and details are not described herein again.

In the several embodiments provided in the present invention, it should be understood that the disclosed apparatus and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on multiple network units. Some or all of the units may be selected according to actual requirements to achieve the objectives of the solutions of the embodiments.

In addition, function units in the embodiments of the present invention may be integrated into one processing unit, or each of the units may exist alone physically, or two or more units are integrated into one unit. The integrated unit may be implemented in a form of hardware, or may be implemented in a form of hardware in addition to a software function unit.

When the foregoing integrated unit is implemented in a form of a software function unit, the integrated unit may be stored in a computer-readable storage medium. The software function unit is stored in a storage medium and includes several instructions for instructing a computer device (which may be a personal computer, a server, or a network device) or a processor to perform some of the steps of the methods described in the embodiments of the present invention. The foregoing storage medium includes any medium that can store program code, such as a USB flash drive, a removable hard disk, a read-only memory (ROM), a random access memory (RAM), a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. A data transmission method in a time division duplex wireless data transmission system, comprising:
receiving, by a second transmission device, a service frame sent by a first transmission device, and receiving an idle frame that is sent by the first transmission device after each time the first transmission device sends a preset quantity of service frames;
performing, by the second transmission device in a timeslot corresponding to the idle frame, interference detection on a to-be-detected frequency band corresponding to the idle frame in an available spectrum, obtaining an interference detection result of the to-be-detected frequency band, and updating the interference detection result of the to-be-detected frequency band in interference statistics of the available spectrum; and
switching, by the second transmission device according to the interference statistics of the available spectrum when interference to a current operating frequency band is greater than a preset threshold, the operating frequency band to a frequency band that meets a preset condition.

2. The method according to claim 1, wherein the performing, by the second transmission device in a timeslot corresponding to the idle frame, interference detection on a to-be-detected frequency band corresponding to the idle frame in an available spectrum comprises:
switching, by the second transmission device in the timeslot corresponding to the idle frame, the current operating frequency band to the to-be-detected frequency band corresponding to the idle frame, and performing interference detection on the to-be-detected frequency band.

3. The method according to claim 2, wherein the performing, by the second transmission device, interference detection on the to-be-detected frequency band comprises:
obtaining, by the second transmission device, received signal strength indication (RSSI) information of the to-be-detected frequency band to perform interference detection on the to-be-detected frequency band.

4. The method according to claim 1, wherein the switching, by the second transmission device according to the interference statistics of the available spectrum when interference to a current operating frequency band is greater than a preset threshold, the operating frequency band to a frequency band that meets a preset condition comprises:
switching, by the second transmission device according to the interference statistics of the available spectrum when the interference to the current operating frequency band is greater than the preset threshold, the operating frequency band to a frequency band that is least interfered with.

5. The method according to claim 3, wherein after the obtaining, by the second transmission device, received signal strength indication (RSSI) information of the to-be-detected frequency band to perform interference detection on the to-be-detected frequency band, the method further comprises:
determining, by the second transmission device, a priority of each frequency band in the available spectrum according to RSSI information of each frequency band in the available spectrum, wherein
interference to a frequency band with a high priority is less than that to a frequency band with a low priority.

6. The method according to claim 5, wherein the switching, by the second transmission device according to the interference statistics of the available spectrum when interference to a current operating frequency band is greater than a preset threshold, the operating frequency band to a frequency band that meets a preset condition comprises:
when the interference to the current operating frequency band is greater than the preset threshold, switching, by the second transmission device, the operating frequency band to a frequency band with a highest priority according to the priority of each frequency band in the available spectrum.

7. A data transmission apparatus in a time division duplex wireless data transmission system, comprising a processor and a transmitter, wherein
the processor is configured to: generate an idle frame and a service frame;
the transmitter is configured to: send the service frame to a second transmission device, send the idle frame to the second transmission device after each time the first transmission device sends a preset quantity of service frames to the second transmission device.

8. A data transmission apparatus in a time division duplex wireless data transmission system, comprising a receiver and a processor, wherein
the receiver is configured to: receive a service frame sent by a first transmission device, and receive an idle frame that is sent by the first transmission device after each time the first transmission device sends a preset quantity of service frames; and
the processor is configured to: perform, in a timeslot corresponding to the idle frame, interference detection on a to-be-detected frequency band corresponding to the idle frame in an available spectrum, obtain an interference detection result of the to-be-detected frequency band, and update the interference detection result of the to-be-detected frequency band in interference statistics of the available spectrum; and switch, according to the interference statistics of the available spectrum when interference to a current operating frequency band is greater than a preset threshold, the operating frequency band to a frequency band that meets a preset condition.

9. The apparatus according to claim 8, wherein the processor is specifically configured to: switch, in the timeslot corresponding to the idle frame, the current operating frequency band to the to-be-detected frequency band corresponding to the idle frame, and perform interference detection on the to-be-detected frequency band.

10. The apparatus according to claim 9, wherein the processor is specifically configured to obtain received signal strength indication (RSSI) information of the to-be-detected frequency band to perform interference detection on the to-be-detected frequency band.

11. The apparatus according to claim 8, wherein the processor is specifically configured to switch, according to the interference statistics of the available spectrum when the interference to the current operating frequency band is greater than the preset threshold, the operating frequency band to a frequency band that is least interfered with.

12. The apparatus according to claim 10, wherein the processor is further configured to: after obtaining the received signal strength indication (RSSI) information of the to-be-detected frequency band to perform interference detection on the to-be-detected frequency band, determine a priority of each frequency band in the available spectrum according to RSSI information of each frequency band in the available spectrum, wherein interference to a frequency band with a high priority is less than that to a frequency band with a low priority.

13. The apparatus according to claim 12, wherein the processor is specifically configured to: when the interference to the current operating frequency band is greater than the preset threshold, switch the operating frequency band to a frequency band with a highest priority according to the priority of each frequency band in the available spectrum.
